(19) United States
(12) Patent Application Publication
(10) Pub. No.: US 2006/0031444 A1
(43) Pub. Date: Feb. 9, 2006

(54) Method for assigning network resources to applications for optimizing performance goals

(76) Inventors: Julie Ward Drew, Redwood City, CA (US); Cipriano A. Santos, Modesto, CA (US); Simge Kucukyavuz, Palo Alto, CA (US); Dirk M. Beyer, Walnut Creek, CA (US); Xiaoyun Zhu, San Jose, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/856,222

(22) Filed: May 28, 2004

(51) Int. Cl. G06F 15/173; G06F 9/46

(52) U.S. Cl. 709/223; 718/102

(57) ABSTRACT

A system and method for improving a network. The system and method may include receiving a virtual topology including a list of application components defining an arbitrary network, resource requirements for the application components and communication requirements between each set of application components and receiving a network topology including a list of physical resources defining an arbitrary capacitated network, specifications for the physical resources, connections between the physical resources and a physical property for each connection. The system and method may also include creating decision variables and constraints to provide an objective function using the virtual topology and the network topology and assigning each application component to at least one physical resource according to the decision variables, the constraints, and the objective function.

### BACKGROUND

The human costs associated with monitoring and managing large, complex information technology (IT) environments has resulted in the move toward more efficient computing utilities. A computing utility can be defined as the ability to provide complex computing environments on-demand to IT users. In a computing utility, IT resources are treated like a utility, where consumers purchase only the needed amount of computing power, similar to the purchase of electricity and telephone service. One goal of a computing utility is to simplify the complexities associated with infrastructure management. One example of a computing utility is a data center where a large pool of IT resources are centrally managed to meet the needs of business critical enterprise applications such as enterprise resource planning applications, database applications, customer relationship management applications, and general e-commerce applications. Managing a computing utility is difficult because each application running within the enterprise has unique assumptions, each enterprise has different policies that are associated with its applications, and each user brings a different set of requirements for their application.

Resource assignment in a computing utility is difficult because the needs of the enterprise users are complex. Many algorithms have been developed to solve the resource assignment problem, however, these algorithms often assume that the topology of resources is a tree, which means that the communication path between resources is unique. Thus, it should be appreciated that there is a need for a resource assignment process that removes this assumption and provides other advances and advantages.

### SUMMARY OF THE INVENTION

One embodiment of the invention is a processor-based method for substantially optimizing performance goals of a network. The method includes receiving a virtual topology including a list of application components defining an arbitrary network, resource requirements for the application components and communication requirements between each set of application components and receiving a network topology including a list of physical resources defining an arbitrary capacitated network, specifications for the physical resources, connections between the physical resources and a physical property for each connection. The method also includes creating decision variables and constraints to provide or substantially optimize an objective function using the virtual topology and the network topology and assigning each application component to at least one physical resource according to the decision variables, the constraints, and the objective function.

These and other features and advantages of the embodiments of the invention will become apparent from the following detailed description, taken in conjunction with the accompanying drawings, which illustrate, by way of example the principles of the invention.

### BRIEF DESCRIPTION OF THE DRAWINGS

FIG. 1 is a simplified architectural diagram of a computing utility system, which can include thousands of processing elements and storage elements connected through a switched fabric according to an embodiment of the invention;

FIG. 2 is a simplified block diagram of a two-step process used to map application requirements to specific resources that are used to host the application according to an embodiment of the invention;

FIG. 3 is a simplified block diagram of a computing utility system according to an embodiment of the invention;

FIG. 4 is a simplified flow chart of a process for assigning resources to applications using the resource assignment module in the utility computing system of FIG. 3 according to an embodiment of the invention;

FIG. 5 is a graph of the virtual topology of a component-based application architecture having nodes representing application components and links representing the communication flow between the application components according to an embodiment of the invention;

FIG. 6 is a graph of a storage access pattern of an application according to an embodiment of the invention;

FIG. 7 is a graph of the network topology of physical resources according to an embodiment of the invention;

FIG. 8 is a graph of an application architecture having application components mapped to resources and links representing the communication flow between the application components according to an embodiment of the invention; and

FIG. 9 is a simplified flow chart of a process for assigning resources to applications according to an embodiment of the invention.

### DETAILED DESCRIPTION

Systems and methods that implement the embodiments of the various features of the invention will now be described with reference to the drawings. The drawings and the associated descriptions are provided to illustrate embodiments of the invention and not to limit the scope of the invention. Reference in the specification to “one embodiment” or “an embodiment” is intended to indicate that a particular feature, structure or characteristic described in connection with the embodiment is included in at least an embodiment of the invention. The appearances of the phrase “in one embodiment” or “in an embodiment” in various places in the specification are not necessarily all referring to the same embodiment. Throughout the drawings, reference numbers are re-used to indicate correspondence between referenced elements. In addition, the first digit of each reference number indicates the figure in which the element first appears.

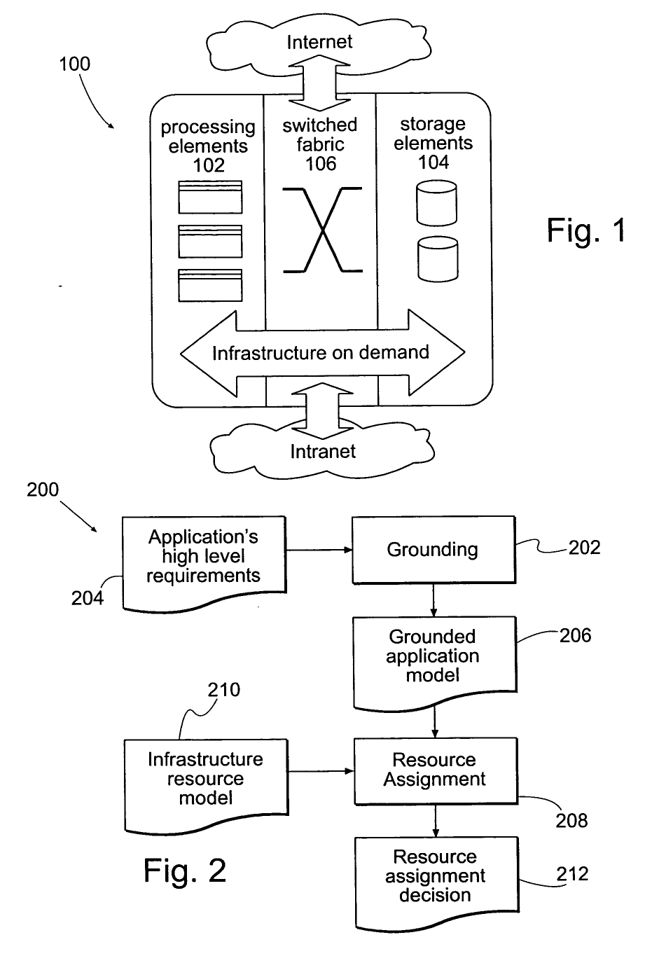

FIG. 1 is a simplified architectural diagram of a computing utility system 100, which can include thousands of processing elements 102 (e.g., servers) and storage elements 104 (e.g., disk arrays) connected through a switched fabric 106 (e.g., a shared high speed Ethernet fabric and a storage area network (SAN) fabric). These resources are virtualized and shared by multiple applications to achieve scalability and increased return on investment. When an application is deployed in the computing utility system 100, it is allocated a partition of resources in a virtual application environment to meet the specific needs of the application. As each application's real-time workload varies over time, resources are dynamically reallocated and redistributed among all running applications to achieve high resource utilization. In most cases, the physical identities of the allocated resources are transparent to the application due to virtualization of resources.

The utility provider is responsible for choosing the right set of physical resources for each application and its components to satisfy the application's configuration and performance requirements, to avoid resource bottlenecks in the infrastructure, to achieve certain goals and to enforce certain policies. This decision making process, often referred to as resource assignment, is an integral part of a resource access management framework that controls the complete lifecycle of applications' access to resources in a computing utility. For large-scale data centers and networks, resource assignment is typically performed by human operators, who are slow, expensive, and error prone. Hence, large-scale computing utilities are susceptible to a resource assignment problem (RAP).

FIG. 2 is a simplified block diagram of a two-step process 200 used to map application requirements to specific resources that are used to host the application. Grounding 202 translates an application's high-level requirements 204 into a grounded application model 206 that represents the low-level processing, communication and storage requirements on the physical resources. Grounding 202 requires a great deal of domain knowledge and experience with the specific application, and typically involves benchmarking exercises. Resource assignment 208 chooses the specific instances of resources from an infrastructure resource model 210 to produce a resource assignment decision 212. Resource assignment requires knowledge and data on the physical resources.

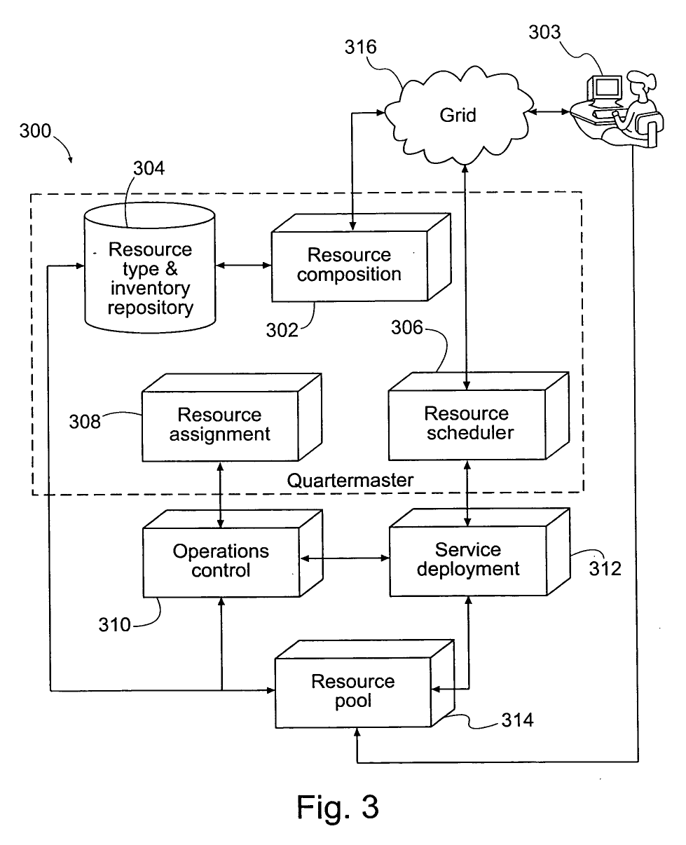

FIG. 3 is a simplified block diagram of a computing utility system 300. The computing utility system 300 allows for the design, deployment and management of arbitrary applications while satisfying their frequently competing requirements for resources. Preferably, the computing utility system 300 is implemented using a combination of hardware and software, however, it can be implemented using only hardware or only software. In one embodiment, the computing utility system 300 includes a resource composition module 302, a resource type and inventory repository module 304, a resource scheduler module 306, a resource assignment module 308, an operations control module 310, a service deployment module 312, a resource pool module 314 and a grid interface 316. In one embodiment, the resource assignment module 308 of the computer utility system 300 can be programmed to operate using a high-level modeling system for mathematical programming such as general algebraic modeling system (GAMS), which was developed by GAMS Development Corporation of Washington, D.C.

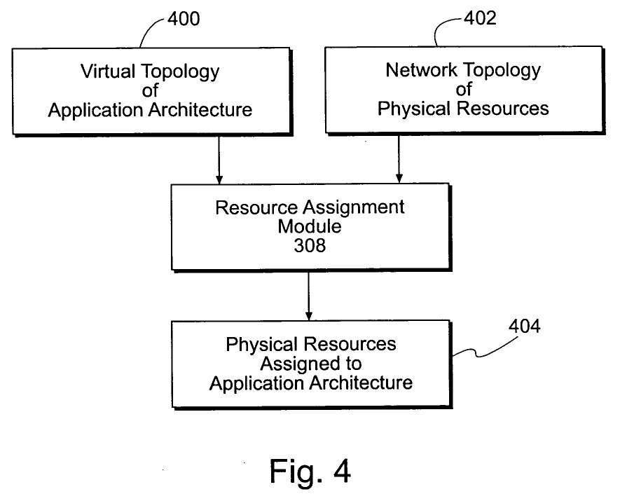

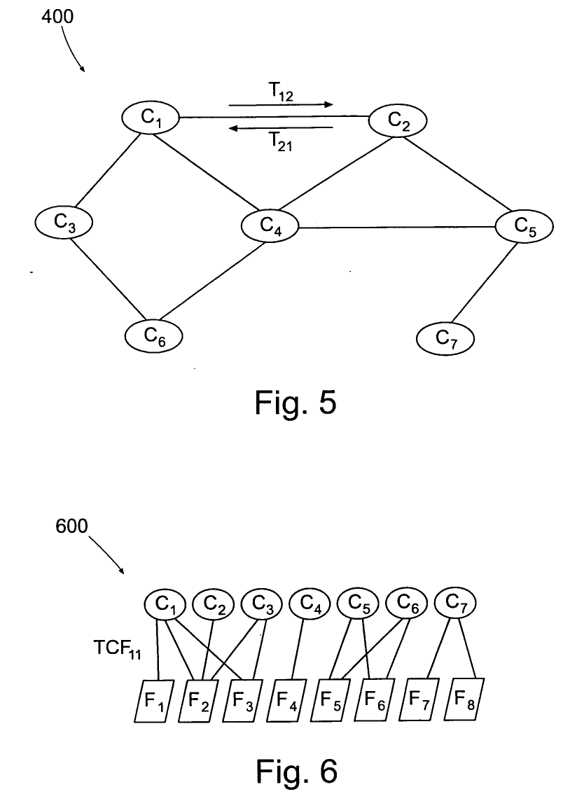

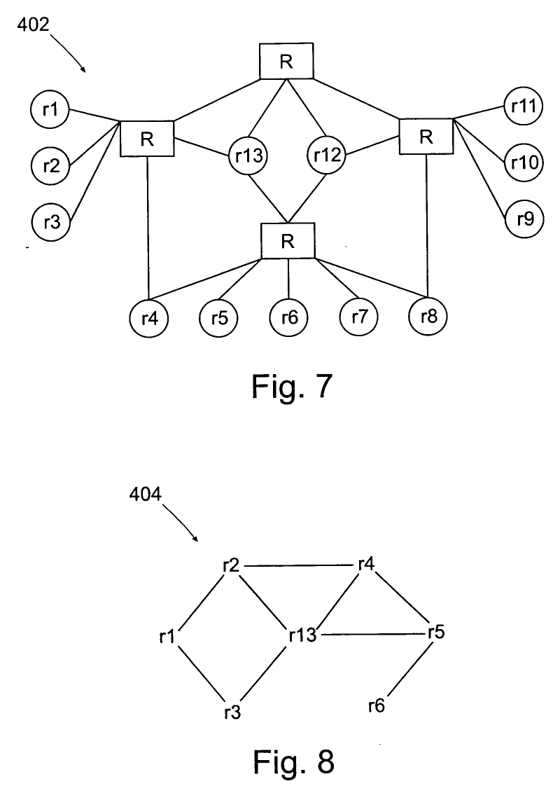

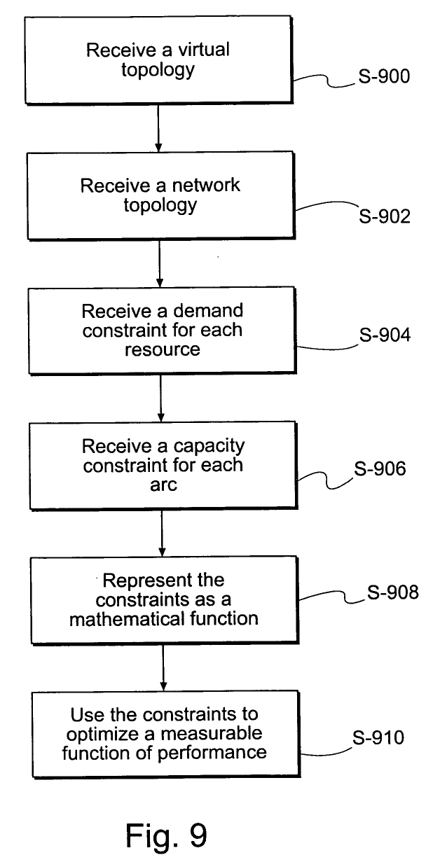

FIG. 4 is a simplified flow chart of a process for assigning resources to applications using the resource assignment module 308 in the utility computing system 300 of FIG. 3. The resource assignment module 308 receives a virtual topology 400 (see also FIG. 5) of the application architecture from the resource composition module 302 (S-900) and a network topology 402 (see also FIG. 7) of physical resources from the resource pool 314 (S-902). The virtual topology 400 and the network topology 402 may be represented as arbitrary graphs. The virtual topology 402 can be an arbitrary network containing its component architecture and requirements. The network topology 402 can be an arbitrary capacitated network topology of physical resources. An arbitrary network means that there are no restrictions as to how the nodes are to be connected. In one embodiment, the arbitrary network does not assume the network topology is a tree. The resource assignment module 308 outputs a resource assignment 404 (e.g., a graph or a table, see also FIG. 8) representing the assignment of the physical resources to the application architecture.

The virtual topology 400 can be a distributed architecture represented using a graph as shown in FIG. 5. For example, FIG. 5 is a graph of the virtual topology 400 of a component-based application architecture in which nodes (Cₙ) represent application components and links (Tₙₙ) represent the communication flow between the application components. The distributed application components can communicate with one another in an arbitrary way. The application components can be represented by a bidirectional graph G(C, L) where each node cεC represents an application component and each link 1=(c, c′) ε L is an ordered pair of component nodes (c, c′) representing the communication flow from component c to component c′. The matrix T is defined to characterize the traffic flow of the application. Each element T_{cc′} represents the maximum amount of traffic going from component c to component c′. If T_{cc′}=0, then no traffic flows from component c to component c′.

Each application component has requirements for being hosted by certain type of servers. For example, suppose P is a set of attributes (or properties) that are of interest to a particular application, such as processor type, processor speed, number of processors, memory size, disk space, and so on. Then, for each attribute p ε P and each application component c ε C, the requirement is characterized by a set VREQ_{cp}, which contains the permissible values of attribute p for component c. The set may be discrete or continuous. For example, an application component may require a server's processor type to be in {SPARC, PA_RISC}, and its processor speed to be in an interval [500, 1000] (in MHz).

The distributed architecture can be converted into an input file or input table containing a list of components and their requirements for processing, communication and storage. The input file or input table is used as the input to the resource assignment module 308. The list of requirements can include, for example, a list of component names, a list of links and the component on each end of the link, the maximum traffic between nodes, the attribute requirements for each component, and so on.

FIG. 6 is a graph of a storage access pattern 600 of an application. Suppose the data for an application can be divided into a set of “files”. The file Fₙ represents a logically contiguous chunk of data that may be accessed by the application components. The storage access pattern 600 of all the components can be represented by a bipartite graph as shown in FIG. 6. The example illustrates that the mapping between an application component and a file is not one-to-one. More specifically, each component may access multiple files, and each file may be accessed by more than one component.

The application model can be used for simultaneous assignment of resources to multiple applications. A graph can be constructed with all the components from all the applications, where each application is represented by a sub-graph. Two sub-graphs are disconnected if the two corresponding applications do not communicate with each other.

Hence, the application model contains the following sets and parameters:

The sets—
c ε C: Set of application components.
f ε F: Set of files to be placed on storage devices.
l ε L: Set of directed links in the application architecture graph.
c′ ε N_{c}: Set of components that communicate with component c, i.e., N_{c}={c′ ε C: (c, c′) ε L}.

The parameters—
T: |C|×|C|—dim matrix. T_{cc′} is the amount of traffic from component c to component c′.
TCF: |C|×|F|—dim matrix. TCF_{cf} is the amount of write traffic from component c to file f.
TFC: |F|×|C|—dim matrix. TFC_{fc} is the amount of read traffic from file f to component c.
TO: |C|—dim vector. TO_{c}=Σ T_{cc′} is the total amount of LAN traffic originating c′ ε N_{c} from component c.
TI: |C|—dim vector. TI_{c}= Σ T_{c′c}is the total amount of LAN traffic received by c′ ε N_{c} component c.

The network topology 402 of physical resources can be represented using a graph as shown in FIG. 6. The network topology 402 of physical resources can be characterized by a set of resources that communicate with one another. In one embodiment, the network topology can be represented by a bidirectional graph G(N, A) where each node n ε N represents a resource and each arc a=(n, n′) ε A represents the bandwidth of the link that goes from node n to node n′. The communication path between the set of resources may not be unique, thus allowing for the use of an arbitrary resource topology.

The network topology 402 of physical resources can be converted into an input file or input table containing a list of resources and a set of parameters that describe the capabilities of these resources. The input file or input table is used as the input to the resource assignment module 308. The list of resources can include, for example, a list of servers (e.g., compute servers, load balancers, firewalls), switches, storage devices, and other components.

Hence, the network model contains the following sets and parameters:

The sets—
s ε S: Set of servers in the network topology.
r ε R: Set of switches in the network topology.
n ε N: Set of nodes in the network topology, including the servers and the switches, i.e., N=S ∪ R.
a ε A: Set of arcs in the network topology. Each arc a is an ordered pair (m, n) of nodes in N.

The parameters—
B: |A|—dim vector. Bₐ or Bₘₙ is the link bandwidth of arc a=(m, n) ε A .

Using the virtual topology 400 and the network topology 402 as inputs, the resource assignment module 308 uses a multi-commodity flow model (i.e., a mathematical model) to characterize the assignment of application components (i.e., nodes in the virtual topology) to the physical resources (i.e., nodes in the network topology), and the routing of traffic between application components on the links in the physical topology. The multi-commodity flow model is a special class of mixed integer programs in which one should route k commodities in a network. Each commodity has a source node and a destination node in the network, as well as a flow requirement that should be routed between the source and the destination. Each arc in the network has flow capacity requirements. The resource assignment module 308 determines, for example, a minimum cost of routing the commodities in the network while satisfying the capacity and flow requirement constraints. These capacity and flow requirement constraints can be represented using mathematical expressions (as described below), which are converted into one or more mathematical programming codes using mixed integer programming (S-904, S-906). That is, the mathematical expressions can be expressed as code using a mathematical programming language. Then, the resource assignment module 308 uses these mathematical programming commands and calls a solver (S-908), such as CPLEX developed by ILOG, Inc. of Mountain View, Calif., to find the optimal or near-optimal solutions for a measurable function of performance (S-910).

The Decision Variables—The resource assignment module 308 selects the right resource (e.g., server) in the utility fabric for each application component, represented by the following matrix of binary variables.

For all c ε C and s ε S, if

x_{cs}=1, the server s is assigned to component c;

x_{cs}=0, otherwise.

In addition, we define a set of continuous nonnegative flow variables W_{cc′mn} to represent the flow along arc (m, n) ε A , in the direction from m to n, that originated from component c and is destined to component c′.

The Constraints—Each constraint represents a requirement relating to the capacity and/or demand of the resource and is expressed as a mathematical expression or function, which can be a mathematical inequality and/or equation. The following is a list of constraints on the decision variables along with well-defined mathematical expressions representing the constraints.

Normality Constraints:

1) Only one server is assigned to each application component.

$${\sum }_{s ∈ S} {x}_{cs} = 1 , ∀ c ∈ C$$

2) Each server is assigned to at most one component.

$${\sum }_{c ∈ C} {x}_{cs} \leq 1 , ∀ s ∈ S$$

Link Capacity Constraints:

3) Link capacity constraints for all arcs (m, n) ε A.

$${\sum }_{( c , {c}^{′} ) ∈ L} {w}_{{cc}^{′} m n} \leq {B}_{mn}$$

Flow Conservation Constraints:

4) Flow conservation for each commodity (c, c′) ε L and each node n ε N.

a) For each switch n ε R, we have

$${\sum }_{m ∈ N \text{:} {( m , n )}_{∈} A} {w}_{{cc}^{′} m n} = {\sum }_{p ∈ N \text{:} ( n , p ) ∈ A} {w}_{{cc}^{′} np}$$

The left side equation represents the total amount of traffic entering switch n, and the right side equation represents the total amount of traffic leaving switch n.

b) For each server node s ε S, we have
i) the incoming traffic is equal to the traffic demand:

$${\sum }_{m ∈ N \text{:} {( m , s )}_{∈} A} {w}_{{cc}^{′} m s} = {x}_{{c}^{′} s} {T}_{{cc}^{′}}$$
ii) the outgoing traffic is equal to the traffic supply:

$${\sum }_{p ∈ N \text{:} {( s , p )}_{∈} A} {w}_{{cc}^{′} sp} = {x}_{cs} {T}_{{cc}^{′}}$$

The flow conservation constraints at the server nodes are split into two equations because for each commodity (c, c′) ε L, the server cannot be the source and the sink at the same time.

SAN Link Capacity Constraints:

5) The SAN traffic going out of each FC edge switch to a core switch does not exceed the link capacity.

$${\sum }_{s ∈ {SED}_{g}} {\sum }_{f ∈ F} {\sum }_{c ∈ C} {TCF}_{cfcs}^{x} {\leq }_{g ,}^{BEC} ∀ g ∈ G$$

6) The SAN traffic coming into each FC edge switch from a core switch does not exceed the link capacity.

$${\sum }_{s ∈ {SED}_{g}} {\sum }_{f ∈ F} {\sum }_{c ∈ C} {TFC}_{fccs}^{x} {\leq }_{g ,}^{BCE} ∀ g ∈ G$$

7) The SAN traffic from an FC core switch to a storage device does not exceed the link capacity.

$${\sum }_{s ∈ {SCO}_{k}} {\sum }_{f ∈ F} {\sum }_{c ∈ C} {{{TCF}_{cfcs}^{x}}^{Y}}_{fd} {{\leq }_{g ,}^{BCD}}_{kd} , ∀ k ∈ K , d ∈ D$$

8) The SAN traffic from a storage device to an FC core switch does not exceed the link capacity.

$${\sum }_{s ∈ {SCO}_{k}} {\sum }_{f ∈ F} {\sum }_{c ∈ C} {{{TFC}_{fccs}^{x}}^{Y}}_{fd} {{\leq }_{g ,}^{BDC}}_{dk} , ∀ k ∈ K , d ∈ D$$

Note that Y_{fd} is a binary parameter, where Y_{fd}=1 if and only if file f is placed on storage device d. Hence, it is another input parameter to the resource assignment module 308. The binary parameter may be computed by a file placement solver.

Assignment Constraints:

9) All the variables are binary, and all the assigned servers, rack switches, and edge switches are feasible.

x_{cs} ε {0, FS_{cs}}

10) Similar feasibility constraints can be posed on the flow variables w_{cc′mn}. For example,
0≦w_{cc′sn}≦T_{cc′}FS_{cs′} ∀ (c,c′) ε L, ∀ s ε S, (s,n) ε A
0≦w_{cc′ms}≦T_{cc′}FS_{c′s′} ∀ (c,c′) ε L, ∀ s ε S, (m,s) ε A

The Objective Function—The resources in a computing utility system can be assigned to application components based on many criteria, such as application performance, resource utilization, operator policies or economic concerns. In one embodiment, the goal is to minimize the total amount of traffic on all the network arcs used by all commodities.

$$Min J1 = {\sum \sum }_{( c , {c}^{′} ) ∈ L ( m , n ) ∈ A} {w}_{{cc}^{′} mn}$$

The above objective function can be shown to be equivalent to minimizing the traffic-weighted average inter-server distance, where distance is measured in terms of network hop count. In general, minimizing J1 results in lower communication delays between application components inside the LAN fabric.

The resource assignment module 308 determines the resources that satisfy the application components given the objective function. For example, the resource assignment module 308 determines the servers in the resource topology that satisfy the application components and traffic requirements of the application architecture. In addition, the resource assignment module 308 determines the traffic flow at each arc of the resource topology that satisfies the bandwidth at each arc while optimizing the network performance. Thereafter, the resource assignment module 308 calls a solver, such as CPLEX, to solve the mixed integer programming problem expressed as the multi-commodity flow model. The results of the solver in graphical format are shown in FIG. 7. Hence, FIG. 7 is a graphical representation of the solution from the solver showing the resources assigned to the application architecture; however, in one embodiment, the output of the solver is a table describing which physical resources are assigned to which application components.

Although an exemplary embodiment of the invention has been shown and described, many other changes, combinations, omissions, modifications and substitutions, in addition to those set forth in the above paragraphs, may be made by one having skill in the art without necessarily departing from the spirit and scope of this invention. Accordingly, the present invention is not intended to be limited by the preferred embodiments, but is to be defined by reference to the appended claims.

What is claimed is:

1. A processor-based method for substantially optimizing performance goals of a network, comprising:
receiving a virtual topology including a list of application components defining an arbitrary network, resource requirements for the application components and communication requirements between each set of application components;
receiving a network topology including a list of physical resources defining an arbitrary capacitated network, specifications for the physical resources, connections between the physical resources and a physical property for each connection;
creating decision variables and constraints to provide an objective function using the virtual topology and the network topology; and
assigning each application component to at least one physical resource according to the decision variables, the constraints, and the objective function.

2. The method of claim 1, wherein the application components are selected from a group consisting of Web servers, application servers, and database servers.

3. The method of claim 1, wherein the physical resources are selected from a group consisting of servers, switches and storage devices.

4. The method of claim 1, wherein the arbitrary network is a network that does not assume the virtual topology is a tree structure.

5. The method of claim 1, wherein the arbitrary capacitated network is a network that does not assume the network topology is a tree structure.

6. The method of claim 1, wherein the physical property is a capacity requirement.

7. The method of claim 1, wherein assigning each application component to at least one physical resource includes using the specifications to determine the physical resource that satisfy the resource requirements.

8. The method of claim 1, wherein assigning each application component to at least one physical resource includes using the physical properties to determine the connections that satisfy the communication requirements.

9. The method of claim 1, wherein the objective function is selected from a group consisting of minimizing the cost of routing the network data and minimizing the traffic-weighted average inter-server distance.

10. The method of claim 1, wherein at least one of the decision variables is represented using binary variables.

11. The method of claim 1, wherein the constraints comprise mathematical inequalities and equations.

12. A processor-based method for assigning a physical resource to a component using a multi-commodity flow model, comprising:
providing a list of components and a resource requirement for each component;
providing a link between a plurality of components representing traffic between the plurality of components, and a communication requirement for each link;
providing a list of nodes representing resources and a specification for each resource;
providing a list of connections between the nodes;
generating constraints using the list of components, the resource requirements, the communication requirements, the list of nodes, the specification and the connections;
providing an objective function; and
assigning the components to the nodes to provide, in part, the objective function.

13. The method of claim 12, further comprising providing a physical property for each connection.

14. The method of claim 13, wherein the physical property is a capacity requirement.

15. The method of claim 12, wherein the communication requirement is a flow capacity requirement.

16. The method of claim 12, wherein the objective function is selected from a group consisting of minimizing the cost of routing the network data and minimizing the traffic-weighted average inter-server distance.

17. The method of claim 12, wherein the constraints comprise mathematical inequalities and equations.

18. A processor-based method for substantially optimizing a measurable function of performance in a network, comprising:
receiving a virtual topology of application components;
receiving a network topology of physical resources;
using the virtual topology and the network topology to express decision variables, constraints and an objective function as a mathematical expression; and
assigning each application component to one physical resource based on the decision variables, the constraints and the objective function.

19. The method of claim 18, wherein the virtual topology includes a list of application components, a resource requirement for each application component and a communication requirement between each set of application components.

20. The method of claim 18, wherein the network topology includes a list of physical resources, a specification for each physical resource, a connection between each set of physical resources and a physical property for each connection.

21. A computing utility system for substantially optimizing performance goals of a network, comprising:
a processor having a resource assignment module;
the resource assignment module configured to receive a virtual topology including a list of application components defining an arbitrary network, resource requirements for the application components and communication requirements between each set of application components;
the resource assignment module configured to receive a network topology including a list of physical resources defining an arbitrary capacitated network, specifications for the physical resources, connections between the physical resources and a physical property for each connection;
the resource assignment module configured to create decision variables and constraints to provide, in part, an objective function using the virtual topology and the network topology; and
the resource assignment module configured to assign each application component to at least one physical resource according to the decision variables, the constraints, and the objective function.

22. The system of claim 21, wherein the application components are selected from a group consisting of Web servers, application servers, and database servers.

23. The system of claim 21, wherein the physical resources are selected from a group consisting of servers, switches and storage devices.

24. The system of claim 21, wherein the arbitrary network is a network that does not assume the virtual topology is a tree structure.

25. The system of claim 21, wherein the arbitrary capacitated network is a network that does not assume the network topology is a tree structure.

26. The system of claim 21, wherein the physical property is a capacity requirement.

27. An apparatus comprising a machine readable medium containing instructions which, when executed by a machine, cause the machine to perform operations for substantially optimizing performance goals of a network, the operations comprising:
receiving a virtual topology including a list of application components defining an arbitrary network, resource requirements for the application components and communication requirements between each set of application components;
receiving a network topology including a list of physical resources defining an arbitrary capacitated network, specifications for the physical resources, connections between the physical resources and a physical property for each connection;
creating decision variables and constraints to provide, in part, an objective function using the virtual topology and the network topology; and assigning each application component to at least one physical resource according to the decision variables, the constraints, and the objective function.

28. The apparatus of claim 27, wherein the communication requirement is a flow capacity requirement.

29. The apparatus of claim 27, wherein the objective function is selected from a group consisting of minimizing the cost of routing the network data and minimizing the traffic-weighted average inter-server distance.

30. The apparatus of claim 27, wherein the constraints comprise mathematical inequalities and equations.
